(19) United States
(12) Patent Application Publication
(10) Pub. No.: US 2002/0042468 A1
(43) Pub. Date: Apr. 11, 2002

(54) Thermosetting resin composition for outer panel of automobile

(76) Inventors: Chi Hoon Choi, Kyoungki-do (KR); Sang Sun Park, Kyoungki-do (KR); Ki Seok Kim, Kyoungki-do (KR); Yong Chul Lee, Kyoungsangbuk-do (KR); Myung Jae Lee, Kyoungsangbuk-do (KR); Sun Suk Lee, Daejeon (KR)

Correspondence Address: BIRCH STEWART KOLASCH & BIRCH, PO BOX 747, FALLS CHURCH, VA, 22040-0747, US

(21) Appl. No.: 09/839,242

(22) Filed: Apr. 23, 2001

(30) Foreign Application Priority Data
Aug. 19, 2000 (KR) 2000-48085

(51) Int. Cl. C08K 3/40

(52) U.S. Cl. 524/494

(57) ABSTRACT

The present invention relates to a thermosetting resin composition for outer panel of automobile, more specifically to a thermosetting resin composition for outer panel of automobile, which uses unsaturated polyester resin instead of usually used thermosetting resin as substrate, comprises filler and glass fiber reinforcing agent as main component, and contains butadiene rubber, low profile agent, curing agent, curing initiator, parting agent, thickening agent and common additives, and is prepared by SMC (Sheet Molding Compounding) method to provide excellent mechanical property and surface appearance property to outer panel of automobile.

### BACKGROUND OF THE INVENTION

1. Field of the Invention

The present invention relates to a thermosetting resin composition for outer panel of an automobile and more specifically, to the thermosetting resin composition for outer panel of an automobile comprising an unsaturated polyester resin unlike general thermosetting resins used to replace conventional metal material with plastic material as a substrate, a filler and a glass fiber reinforcing agent as an main component, butadiene rubber, a low profile agent, a curing agent, a curing initiator, a parting agent, a thickening agent and common additives. The thermosetting resin composition provides excellent mechanical properties and surface properties to outer panel of an automobile prepared by SMC (Sheet Molding Compounding) method.

2. Description of the Prior Art

In general, the outer panel of an automobile is made of metal material, which is disadvantageous in processing and economical efficiency for low volume production compared with plastic material. Especially for automobiles, continuous researches are being conducted to replace the metal material used for inner and outer part with plastic material. However, since the outer part of an automobile should have good impact resistance, the plastic material for replacing metal should have at least equal physical properties compared with metals.

Therefore, a thermosetting resin is drawing attention as an alternative material for metal, among which fiber reinforced plastic (FRP) is known to have equal or better physical properties compared to metal. The fiber reinforced plastic is a thermosetting resin composition with dramatically improved mechanical properties because it contains a reinforcing agent and a filler. Its physical properties can be adjusted by a kind and amount of a resin, a reinforcing agent, a filler, etc.

However, a thermosetting resin composition is cured while molded, and its physical properties are changed depending on a molding temperature, time, etc. Since it is difficult to adjust physical properties, superior technique and molding machine are needed in the mass production. As a result, a method of curing and molding SMC (sheet molding compound) resin simultaneously is being applied. SMC resin is an intermediate molding material semi-hardened by adding additives such as low profile agent, a thickening agent, a curing agent and a pigment to liquid resin and infiltrating it with glass reinforced fiber. The molding method using SMC resin is advantageous in mass production because automation is easy and molding cycle is short. However, its surface quality and volume stability are not sufficient to be used as outer panel of automobile.

### SUMMARY OF THE INVENTION

As explained above, there is little practical example of replacing metal material of outer panel of an automobile with plastic material.

Hereupon, the inventors made intensive efforts to prepare outer panel of an automobile using a thermosetting resin composition being represented as a fiber reinforced resin in order to attain the lightweight of an automobile. As a result, the thermosetting resin composition with improved flexibility and impact resistance was obtained by using thermosetting resin composition, comprising an unsaturated polyester resin as a base and a reinforcing agent and a filler as main components, a low profile agent to enhance a surface quality for use in SMC method, and a butadiene rubber component. By using this thermosetting resin composition, preparation of Class “A” composition was made possible, outer panel of automobile with improved moldability and mechanical property was obtained through SMC method. Hence, the present invention was completed.

Accordingly, an object of the present invention is to provide a thermosetting resin composition to replace the conventional outer panel of an automobile with reinforced plastic. Another object of the present invention is to provide outer panel of an automobile manufactured by SMC method using said composition.

### DETAILED DESCRIPTION OF THE INVENTION

The present invention is characterized by a thermosetting resin composition for outer panel of an automobile comprising an unsaturated polyester resin as a substrate and a filler and a glass fiber reinforcing agent as main components, and additives, wherein: 5-35 wt. % of the unsaturated polyester resin for said substrate, 20-35 wt. % of the glass fiber reinforcing agent, 30-60 wt. % of the filler, 1-20 wt. % of low profile agent, 1-20 wt. % of butadiene rubber, 0.5-35 wt. % of vinyl monomer, 0.01-2 wt. % of curing initiator, 0.1-5 wt. % of parting agent, 0.05-10 wt. % of thickening agent and 0.05-5 wt. % of common additives, one or more selected from the group consisting of pigment, heat stabilizer, UV stabilizer and polymerization inhibitor.

The present invention is also characterized by a preparing method of the thermosetting resin composition for outer panel of an automobile, wherein said thermosetting resin composition for outer panel of an automobile is prepared by SMC method. In SMC method, SMC (sheet molding compound), which is semi-cured thermosetting intermediate molding material processed in sheet form, is used.

Hereunder is given the more detailed description of the present invention.

The outer panel of the automobile manufactured by SMC method using the thermosetting resin composition of the present invention has superior impact resistance, scratch resistance and surface quality and low specific gravity. So, it can replace the metal material used for conventional outer panel of an automobile, and helps to attain the lightweight of an automobile.

The present invention relates to outer panel material of an automobile manufactured by SMC method using the thermosetting resin composition comprising an unsaturated polyester resin as a substrate, a filler and a glass fiber reinforcing agent as main components, a low profile agent, butadiene rubber, vinyl monomer, a curing initiator, a parting agent, a thickening agent and common additives.

Hereunder is given more detailed description of each composition of the present invention.

Firstly, the unsaturated polyester resin used as a substrate in the present invention contains double bonds in the molecular, which hardens through heat and improves physical properties of the resin. Said unsaturated polyester resin is selected one or more from the group consisting of iso resin, ortho resin, tere resin, modified bisphenol and vinyl ester resin and used in the range of 5-30 wt. %, preferably in the range of 10-25 wt. %.

The glass fiber is uniformly infiltrated in the mixed composition containing unsaturated polyester, and therefore can greatly enhance mechanical properties. Length of said glass fiber reinforcing agent is 0.64-5.08 mm. The length of the reinforcing agent is closely related to physical properties. If it is too short, mechanical properties worsen; and otherwise if it is too long, some cracking may occur during the process. A content of the reinforcing agent is 20-35 wt. % to the entire composition, preferably 25-30 wt. %. If the amount is too small, the mechanical property worsens; and if it is too large, it decreases surface quality and processability.

The filler can be any general one used in resin compositions, i.e., one or more selected from calcium carbonate (CaCO₃), mica, talc, clay, silica sphere and ceramic bead can be used. A content of the filler is 30-60 wt. % to the entire composition, preferably 40-50 wt. %. If its content is too high, the physical property, especially impact strength, worsens; and otherwise it is too low, it becomes uneconomical.

In the present invention, various components can be combined for use as additives with the purpose of improving the mechanical property, surface appearance quality and moldability. For the additives, low profile agent, butadiene rubber, vinyl monomer, curing initiator, parting agent and thickening agent, and general additives such as pigment, heat stabilizer, UV stabilizer and polymerization inhibitor can be used. Some of said components can be omitted, but it is recommended to use all the additives listed above.

The low profile agent among the additives used in the present invention, is added to solve the surface defect and decreased volume stability of the general SMC products, and improve the surface smoothness to make the surface of the molded part mirror-like. For the low profile agent, a polymer resin containing ester groups (-COO-) is used to increase an affinity to the unsaturated polyester used as a substrate. Among them, it is recommended to use polymethyl metacrylate (PMMA), polyvinyl acetate (PVAc), saturated polyester or polyurethane in the range of 1-20 wt. %, preferably in the range of 2.5-10 wt. %. If the range deviates from the range, the surface quality and volume stability worsen or it becomes uneconomical.

Butadiene rubber is added to improve an impact resistance and flexibility of the resin composition in order to make it easily applicable for use as outer panel of vertical automobile body. One or more selected from acrylonitrile-butadiene copolymer (NBR), styrene-butadiene copolymer (SBS), styrene-ethylene-butadiene-styrene copolymer (SEBS), carboxyl-terminated modified rubber and epoxy rubber prepared from said modified rubber is used. Butadiene rubber of the present invention is recommended to be used in the range of 1-20 wt. %, preferably in the range of 3-10 wt. %. If it deviates this range, the impact resistance and flexibility become poor.

Vinyl monomer is added for the curing reaction and selected one or more from the group consisting of styrene, methyl metacrylate, divinylbenzene (DVB), α-methylstyrene, vinyl acetate and acrylate. The curing initiator which acts as a catalyst of the curing reaction, is selected from the group consisting of peroxyester, dialkyl peroxide, alkyl aryl peroxide, diaryl peroxide, peroxyketal, ketone peroxide and azo compound in the range of 0.01-2 wt. %, preferably in the range of 0.1-1 wt. %.

The parting agent is added in the range of 0.1-5 wt. %, and preferably in the range of 0.5-2 wt. % to improve a parting efficiency. Examples include zinc stearate or calcium stearate. The thickening agent is added in the range of 0.05-10 wt. %, preferably in the range of 0.2-5 wt. % to facilitate an efficiency of SMC method by increasing the viscosity. Examples include CaO, Ca(OH)₂, MgO or Mg(OH)₂.

For the common additives, pigment, heat stabilizer, UV stabilizer and polymerization inhibitor can be used in the range of 0.01-5 wt. %, preferably in the range of 0.03-2 wt. %.

The thermosetting resin composition can be prepared with the above composition and content.

The present invention is also characterized by a preparing method of thermosetting resin composition for outer panel of an automobile, wherein said thermosetting resin composition for outer panel of an automobile is prepared by SMC method. In SMC method, SMC (sheet molding compound), which is semi-cured thermosetting intermediate molding material processed in sheet form, is used.

SMC method is a molding method of thermosetting composite material. Firstly, the resin mixture is cut with determined width on the upper and down carrier films using a doctor blade, and then glass fiber is infiltrated between them after cutting it with determined length using a rotary chopper. After pressing said composition with a pressing roller to be sheet form having 1-5 mm of thickness and 0.3-1.5 m of width, the sheet is cut and molded at 130-150° C. of temperature, under the pressure of 50-70 kgf/cm² in general or more than 100 kgf/cm² for very large size and/or complex parts.

When SMC method is used, automation is facilitated and the molding cycle becomes short. So, it is advantageous in mass production compared with other methods, and provides good physical properties. Especially, since the low profile agent is contained in the thermosetting resin composition, the surface defect of SMC material is solved and a molded product with Class “A” represented with Diffracto D-sight Number. The one with low Diffracto D-sight Number is more mirror-like, and Class “A” is given to the product with Diffracto D-sight Number smaller than 120.

The specific gravity of the molded product prepared with SMC method using the thermosetting resin composition of the present invention is in the range of 1.8-1.95, which can be adjusted by a content of glass fiber reinforcing agent and filler. Considering that the metal material used for the outer panel of automobile requiring superior surface quality and impact resistance has the specific gravity of 7.8, and its thickness is generally 0.65-0.75 mm, the present invention can provide 15-35% of weight reduction effect with 2.0-2.5 mm thickness of plastic material. Furthermore, the SMC method thermosetting resin composition obtained from the present invention also has superior corrosion resistance, impact resistance and dent resistance, which are typically provided with plastic. So, it restores to an original shape in case of low-speed collision, and can be effectively used for the manufacture of outer panel of automobile such as hood, door, roof and trunk lid.

Hereunder is given the detailed description of the present invention using Examples. However, they should not be construed as limiting the scope of the present invention.

### EXAMPLES 1-4

Using SMC mixer for laboratory use, about 20 kg of resins in sheet forms with the composition and content as in the following Table 1 were prepared. After thickening at 45° C. for 30 hr, 300 t of pressure was applied to obtain a molded part in plate form. The finally molded SMC had 3.0 mm of thickness. 2.54 mm of glass fiber for the glass fiber reinforcing agent, t-butyl perbenzoate for the initiator, zinc stearate for the parting gent, calcium oxide for the thickening agent, and calcium carbonate for a filler were used.

TABLE 1

| Content (wt. %) | Example 1 | Example 2 | Example 3 | Example 4 |
|---|---|---|---|---|
| Unsaturated Polyester | 17.4 | 16.2 | 16.2 | 15.9 |
| Resin¹⁾ | | | | |
| Low profile agent²⁾ | 4.5 | 4.2 | 4.2 | 4.0 |
| Monomer³⁾ | 2.6 | 2.4 | 2.4 | 3.3 |
| Rubber-1⁴⁾ | 1.7 | 3.4 | — | 5.4 |
| Rubber-2⁵⁾ | — | — | 3.4 | — |
| Initiator | 0.5 | 0.5 | 0.5 | 0.5 |
| Parting Agent | 1.0 | 1.0 | 1.0 | 0.9 |
| Thickening Agent | 0.5 | 0.5 | 0.5 | 0.5 |
| Inorganic Filler | 44.9 | 44.9 | 44.9 | 44.0 |
| Glass Fiber | 26.9 | 26.9 | 26.9 | 26.5 |

Note:
¹⁾OS-108, Aekyung Chemical's product
²⁾Polyvinyl ester low profile agent (PVAc type), LPV-40, Aekyung Chemical's product
³⁾Styrene
⁴⁾Rubber-1: CTBN (carboxyl acid terminated butadiene acrylonitrile) modified epoxy resin, Kukdo Chemical's KR-450 (Grade Name)
⁵⁾Rubber-2: ETBN (epoxy terminated butadiene-acrylonitrile), B F Goodrich's product, 1300X40 (Grade Name), liquid polymer resin

### EXAMPLES 5-8

Sample was prepared under the same condition of Example 1. However, Aropol 50411 (Ashland) for the unsaturated polyester resin, and Aropol 59079 (Ashland) containing a thickening agent and styrene monomer for the low profile agent were used. The composition and content are shown in the following Table 2.

TABLE 2

| Content (wt. %) | Example 5 | Example 6 | Example 7 | Example 8 |
|---|---|---|---|---|
| Unsaturated Polyester | 19.1 | 17.5 | 17.5 | 14.4 |
| Resin | | | | |
| Low Profile Agent | 4.2 | 3.8 | 3.8 | 3.2 |
| Rubber-1 | 1.7 | 3.7 | — | 7.4 |
| Rubber-2 | — | — | 3.4 | — |
| Initiator | 0.5 | 0.5 | 0.5 | 0.5 |
| Parting Agent | 1.0 | 1.0 | 1.0 | 1.0 |
| Inorganic Filler | 45.5 | 45.5 | 45.5 | 45.5 |
| Glass Fiber | 28.0 | 28.0 | 28.0 | 28.0 |

### COMPARATIVE EXAMPLES 1-4

Samples were prepared under the same condition of Example 1 with the composition and content shown in the following Table 2. OS-108 (Aekyung Chemical) for the unsaturated polyester resin; LPV-40 for the low profile agent-1; and polyurethane (PU) type LPU-70 (Aekyung Chemical) for the low profile agent-2 were used. Other components were the same as in the Examples.

TABLE 3

| Content | Comparative | Comparative | Comparative | Comparative |
|---|---|---|---|---|
| (wt. %) | Example 1 | Example 2 | Example 3 | Example 4 |
| Unsaturated | 19.5 | 16.5 | 12.0 | 12.0 |
| Polyester Resin | | | | |
| Low Profile | — | 4.5 | 9.0 | — |
| Agent-1 | | | | |
| Low Profile | — | — | — | 9.0 |
| Agent-2 | | | | |
| Monomer | 2.0 | 2.5 | 2.5 | 2.5 |
| Initiator | 0.5 | 0.5 | 0.5 | 0.5 |
| Parting Agent | 1.0 | 1.0 | 1.0 | 0.5 |
| Thickening | 0.5 | 0.5 | 0.5 | 0.5 |
| Agent | | | | |
| Inorganic Filler | 46.5 | 46.5 | 46.5 | 46.5 |
| Glass Fiber | 30.0 | 28.0 | 28.0 | 28.0 |

### EXPERIMENTAL EXAMPLE

Samples were prepared to determine physical properties of thermosetting resin composition prepared in Examples 1-8 and Comparative Examples 1-4. The following testing methods were used and the result is shown in the following Table 4.

1. Specific gravity: ASTM 792

2. Tensile strength: ASTM 638, Type I; Crosshead speed=5 mm/min

3. Flexural strength and flexural elasticity: ASTM 790; W×L=25×75 mm; Crosshead speed=1.3 mm/min

4. Impact strength: ASTM D256 (Izod type)

5. Surface quality: Diffracto D-sight Number

TABLE 4

| | | Tensile | Flexural | Flexural | Impact | Surface |
|---|---|---|---|---|---|---|
| | Specific | Strength | Elasticity | Strength | Strength | Quality |
| Items | Gravity | (MPa) | (GPa) | (MPa) | (J/m) | (D-sigh) |
| Example 1 | 1.9 | 82 | 10.2 | 196 | 915 | 91 |
| Example 2 | 1.9 | 87 | 9.9 | 183 | 950 | 88 |
| Example 3 | 1.9 | 86 | 9.8 | 185 | 900 | 92 |
| Example 4 | 1.9 | 72 | 8.6 | 170 | 1060 | 89 |
| Example 5 | 1.9 | 70 | 9.6 | 150 | 900 | 85 |
| Example 6 | 1.9 | 64 | 8.0 | 139 | 920 | 70 |
| Example 7 | 1.9 | 70 | 9.4 | 139 | 910 | 94 |
| Example 8 | 1.9 | 62 | 7.5 | 135 | 1100 | 80 |
| Comparative | 1.9 | 100 | 14.3 | 230 | 880 | 160 |
| Example 1 | | | | | | |
| Comparative | 1.9 | 95 | 13.4 | 220 | 800 | 98 |
| Example 2 | | | | | | |
| Comparative | 1.9 | 90 | 12.5 | 205 | 850 | 92 |
| Example 3 | | | | | | |
| Comparative | 1.9 | 70 | 11.5 | 193 | 890 | 90 |
| Example 4 | | | | | | |

In Table 4, since the specific gravity of the compositions prepared from Examples 1-8 and Comparative Examples 1-4 is very low at 1.9, they can replace steel for the use as outer panel of automobile to reduce the weight of automobiles. Samples of Examples 1-8 have high impact strength and superior surface quality with low Diffracto D-sight Number. So, it falls within Class “A”.

On the other hand, the samples of Comparative Examples 1-4 showed low impact strength because rubber was not used. Especially, for Comparative Example 1, the surface quality was very poor since neither rubber nor low profile agent was used. For Comparative Example 2, the surface quality was improved using low profile agent, however, it still showed low impact strength and high flexural strength and elasticity.

As explained in detail above, the thermosetting resin composition comprising unsaturated polyester resin as substrate, reinforcing agent and filler as main components, a low profile agent and polybutadiene rubber was prepared. This thermosetting resin composition showed equal or superior impact resistance and good surface quality compared with conventional metal products. The effect of the present invention can be summarized as follows.

Firstly, 25-35% of weight reduction is possible when used for outer panel of automobile compared with metal material due to its low specific gravity. As a result, improvement of fuel efficiency and reduction of emission gas can be obtained. Especially, if the entire outer panel of automobile including roof panel, side panel, quota panel, fender, door, hood and trunk lid are replaced with SMC developed in the present invention, about 20-30 kg of weigh reduction effect can be obtained.

Secondly, since the dent resistance and impact resistance are superior, it is useful for outer panel of automobile, and the cost for maintenance and repair is saved. Also, the corrosion resistance is fundamentally solved since plastic is used as source material.

Thirdly, the superior moldability compared with metal makes design easy. Especially, since it is streamlined and free styling is possible, the outer appearance is good and fuel efficiency is improved due to the decrease of air resistance coefficient. Fourthly, while at least 3 or 4 sets of molds are required for metal material is used, only 1 set is sufficient for the present invention. So, it provides more than 50% of cost reduction effect in case of low volume production of special automobiles such as electric cars, hybrid cars, and fuel cell cars.

Fifthly, since the required properties and thickness can be changed with the manufacturing process modification, optional change is easily performed. Also, since the mold can be easily modified, design change is easily performed.

What is claimed is:

1. A thermosetting resin composition for outer panel of automobile comprising unsaturated polyester resin as substrate, a filler and a glass fiber reinforcing agent as main components and additives, wherein 5-35 wt. % of unsaturated polyester resin, 20-35 wt. % of glass fiber reinforcing agent, 30-60 wt. % of filler, 1-20 wt. % of low profile agent, 1-20 wt. % of butadiene rubber, 0.5-35 wt. % of vinyl monomer, 0.01-2 wt. % of curing initiator, 0.1-5 wt. % of parting agent, 0.05-10 wt. % of thickening agent and 0.05 wt.-5 wt. % of common additives one or more selected from the group consisting of a pigment, a heat stabilizer, a UV stabilizer and a polymerization inhibitor are comprised.

2. The thermosetting resin composition for outer panel of automobile according to claim 1, wherein said unsaturated polyester resin is one or more selected from the group consisting of iso resin, ortho resin, tere resin, modified bisphenol, bisphenol and vinyl ester resin.

3. The thermosetting resin composition for outer panel of automobile according to claim 1 wherein said glass fiber reinforcing agent is a glass fiber with 0.64-5.08 mm of length.

4. The thermosetting resin composition for outer panel of automobile according to claim 1 wherein said filler is one or more selected from the group consisting of calcium carbonate (CaCO₃), mica, talc, clay, silica sphere and ceramic bead.

5. The thermosetting resin composition for outer panel of automobile according to claim 1, wherein said low profile agent is a polymer resin having ester group (-COO-).

6. The thermosetting resin composition for outer panel of automobile according to claim 5, wherein said low profile agent is selected from the group consisting of polymethyl metacrylate (PMMA), polyvinyl acetate (PVAc), saturated polyester and polyurethane.

7. The thermosetting resin composition for outer panel of automobile according to claim 1, wherein said butadiene rubber is one or more selected from the group consisting of acrylonitrile-butadiene copolymer (NBR), styrene-butadiene copolymer (SBS), styrene-ethylene-butadiene-styrene copolymer (SEBS), carboxylic acid-terminated modified rubber and epoxy rubber prepared from said modified rubber.

8. The thermosetting resin composition for outer panel of automobile according to claim 1, wherein said vinyl monomer is one or more selected from the group consisting of styrene, methyl m-acrylate, divinylbenzene (DVB), α-methylstyrene, vinyl acetate and acrylate.

9. The thermosetting resin composition for outer panel of automobile according to claim 1, wherein said curing initiator is one or more selected from the group consisting of peroxyester, dialkyl peroxide, alkyl aryl peroxide, diaryl peroxide, peroxyketal, ketone peroxide and azo compound.

10. The thermosetting resin composition for outer panel of automobile according to claim 1, wherein said parting agent is zinc stearate or calcium stearate.

11. The thermosetting resin composition for outer panel of automobile according to claim 1, wherein said thickening agent is selected from the group consisting of CaO, Ca(OH)₂, MgO and Mg(OH)₂.

12. A preparing method of thermosetting resin composition for outer panel of automobile using SMC (sheet molding compound) method, wherein the semi-hardened thermosetting intermediate molding material (SMC) processed in sheet form from the thermosetting resin composition of claim 1 is used.
